(19) United States
(12) Patent Application Publication
(10) Pub. No.: US 2007/0106434 A1
(43) Pub. Date: May 10, 2007

(54) User interface for railroad dispatch monitoring of a geographic region and display system employing a common data format for displaying information from different and diverse railroad CAD systems

(76) Inventors: Robert E. Galbraith II, Pittsburgh, PA (US); C. Franklin Boyle, Pittsburgh, PA (US); C. Wesley Mcquiston, Pittsburgh, PA (US); William B. Christie, Allison Park, PA (US)

Correspondence Address: Kirk D. Houser;Eckert Seamans Cherin & Mellott, LLC, 44th Floor, 600 Grant Street, Pittsburgh, PA, 15219, US

(21) Appl. No.: 11/268,691

(22) Filed: Nov. 7, 2005

(51) Int. Cl. G06F 17/00

(52) U.S. Cl. 701/19

(57) ABSTRACT

A display system for displaying information from plural different and diverse railroad Computer-Aided Dispatch (CAD) systems includes a web server, a number of display clients served by the web server, and plural data interfaces communicating to the web server employing a common data format. Each of the data interfaces receives a different and diverse data format from a corresponding one of the different and diverse railroad CAD systems and converts the same to the common data format. The display clients may include a user interface display for railroad dispatch monitoring of a geographic region. The display includes a plurality of train track diagrams for the geographic region, in which the train track diagrams are substantially oriented in a first direction and a different second direction, which is substantially normal to the first direction.

### BACKGROUND OF THE INVENTION

1. Field of the Invention

This invention pertains generally to railroad dispatch monitoring and, more particularly, to user interfaces for railroad dispatch monitoring of one or more railroads. The invention also pertains to display systems employed for reporting, monitoring or displaying railroad information or for controlling a railroad.

2. Background Information

Many large metropolitan areas, Chicago being a particularly striking example, are witness to the convergence of multiple railroads' right-of-ways, which cross at grade in many locations and over which trains are frequently handed off from one property to another. Because these areas are centers of commerce, there are relatively large counts of trains simultaneously traveling within a relatively small geographic region. Not surprisingly, such areas have become choke points within the railroad network, causing trains to spend far too much time moving across them. Coupled with projected increases in railroad traffic (e.g., intermodal transport alone is rising approximately 10% per year), this foreshadows even greater congestion along with concomitant slowdowns and blocked highway crossings, threatening to severely curtail future growth opportunities within the railroad industry. This also suggests an increased likelihood of problems with the traveling public and with local, state and federal authorities.

Responding to this situation, for example, in the specific case of Chicago, the railroads, the State of Illinois, the City of Chicago, Cook County and the Federal government have teamed to form the Chicago Region Environmental And Transportation Efficiency Project (CREATE). The overall program includes a series of projects targeted at mitigating the effects of increasing railroad traffic, while at the same time improving safety and enhancing throughput. Central to the program and its success are civil projects involving highway grade crossing separations, rail-to-rail fly-overs, and the update/upgrade of older interlockings. The freight railroads along with the Chicago commuter railroad authority, Metra, coordinate freight/passenger operations in the Chicago area through the Chicago Transportation Coordination Office (CTCO).

It is believed that an overview capability for plural different railroads is currently not available because each railroad is not able to “see” all foreign railroad trains when the latter are approaching their tracks. Moreover, this information is communicated manually, leaving what is, at best, a fragmented view of traffic flow across the geographic region of interest. At present, each railroad monitors only its own right-of-way using computer screens that display where other railroads' tracks cross, but with little or no advance notice about approaching trains. When required to make a move into or across another railroad, a dispatcher has to contact his peer dispatcher on the other railroad to coordinate the move. Since neither dispatcher can see the condition of the other dispatcher's territory, one or more telephone calls (and/or facsimiles (i.e., faxes)) may be required to accomplish this operation. It is believed that there is presently no other way for acquiring the needed information.

While the dispatcher could obtain a schedule or train status lineup, there is no guarantee that the projected arrival times will be met. Updates would have to be obtained by telephone (or facsimile) as well. All of this is cumbersome, taking too much time and making it difficult to effectively manage train moves and congestion where plural railroads are involved.

As shown in FIG. 1, it is known to employ railroad track displays in a “Z” configuration 2 in which the tracks, such as 4,5,6, are substantially oriented in the horizontal direction. Some of these railroad track displays employ some diagonal turnouts, such as 8, and/or display some vertical trackage (not shown) for turn-arounds, major junctions and/or entrances into yards. It is believed that such railroad track displays are not intended to convey actual directions within their geographic region of interest.

There is room for improvement in user interfaces for railroad dispatch monitoring.

There is also room for improvement in display systems for displaying information from railroad Computer-Aided Dispatch (CAD) systems.

### SUMMARY OF THE INVENTION

These needs and others are met by the present invention, which provides a user interface for railroad dispatch monitoring of a geographic region in which train track diagrams are substantially oriented in (a) at least a first direction and (b) a different second direction, which is substantially normal to the first direction. Both of the at least a first direction and the different second direction approximate the directions of the train tracks of the geographic region. The invention also provides a plurality of data interfaces communicating to a server employing a common data format, in which each of the data interfaces receives a different and diverse data format from one of different and diverse railroad Computer-Aided Dispatch (CAD) systems and converts the same to the common data format.

As one aspect of the invention, a user interface is for railroad dispatch monitoring of a geographic region including at least one railroad having a plurality of train tracks. The user interface comprises: at least one display comprising a plurality of train track diagrams for the geographic region, wherein the train track diagrams are substantially oriented in (a) at least a first direction and (b) a different second direction, which is substantially normal to the first direction, and wherein both of the at least a first direction and the different second direction approximate the directions of the train tracks of the geographic region.

The at least one railroad may be a plurality of different railroads, and the geographic region may include the different railroads.

The train track diagrams may be substantially oriented in a North-South direction, an East-West direction and at least one diagonal direction in between the North-South direction and the East-West direction.

The at least one railroad may include at least one train having a position. The at least one display and the train track diagrams may display the position of the at least one train. The position of the at least one train may be displayed in real time as the at least one train moves through the geographic region.

As another aspect of the invention, a display system for displaying information from a plurality of different and diverse railroad CAD systems comprises: a server; a number of display clients served by the server; and a plurality of data interfaces communicating to the server employing a common data format, each of at least some of the data interfaces being structured to receive a different and diverse data format from a corresponding one of the different and diverse railroad CAD systems and convert the same to the common data format.

At least some of the data interfaces may include the same type of physical interface to corresponding ones of the different and diverse railroad CAD systems.

At least some of the data interfaces may include different types of physical interfaces to corresponding ones of the different and diverse railroad CAD systems.

The different and diverse railroad CAD systems may include a plurality of different proprietary data formats. The data interfaces may include corresponding conversion programs structured to translate a corresponding one of the proprietary data formats to the common data format.

The display clients may include a train dispatch display, which may include a plurality of train track diagrams for the geographic region. The train track diagrams may be substantially oriented in at least a first direction and a different second direction which is substantially normal to the first direction.

### BRIEF DESCRIPTION OF THE DRAWINGS

A full understanding of the invention can be gained from the following description of the preferred embodiments when read in conjunction with the accompanying drawings in which:

FIG. 1 is an example dispatch computer screen display employing a “Z” configuration of tracks for a single railroad.

FIG. 2A is an example overview display for a relatively small portion of a geographic region of interest in accordance with the present invention.

FIG. 2B is an example array of plural display screens displaying the entire geographic region of interest including various overview displays for corresponding portions of the geographic region in accordance with an embodiment of the invention.

FIG. 3 is a block diagram in schematic form of a display system providing overview displays for plural different railroads of a geographic region of interest in accordance with an embodiment of the invention.

FIG. 4 is a flowchart of firmware executed by one of the conversion programs of FIG. 3.

FIG. 5 is a flowchart of firmware executed by the web server of FIG. 3.

### DESCRIPTION OF THE PREFERRED EMBODIMENTS

As employed herein, the term “number” shall mean one or an integer greater than one (i.e., a plurality).

As employed herein, the terms “railroad” or “railroad service” shall mean freight trains or freight rail service, passenger trains or passenger rail service, transit rail service, and commuter railroad traffic, commuter trains or commuter rail service.

As employed herein, the terms “traffic” or “railroad traffic” shall mean railroad traffic, which consists primarily of freight trains and passenger trains, and commuter railroad traffic, which consists primarily of passenger trains, although it can include freight trains.

The present invention is described in association with a particular geographic region and in association with particular railroad Computer-Aided Dispatch (CAD) systems, although the invention is applicable to a wide range of areas where plural railroads converge, and to display systems displaying information from a wide range of railroad CAD systems.

The disclosed plural railroad dispatch monitoring system includes a common data format that all railroads can utilize. The common data format specifies a data protocol schema for communicating information from different and diverse railroad CAD systems. The disclosed system improves the coordination of railroad service in, for example, relatively heavily trafficked metropolitan areas or where there are major interchanges between plural different railroads. The disclosed system and common data format enable the information from any railroad dispatch system (including, for example, tracks, signals, switches, train occupancy and train ids) to be integrated into a single overview display. The output of the system is the overview display for plural railroads that encompasses a geographic region of interest (e.g., without limitation, two or more railroads running through a relatively high percentage of the Chicago area; all the railroads running through the Chicago area, resulting in a fully integrated railroad overview display for the entire Chicago area).

Accordingly, one way to help address the congestion problem is to monitor and display, in real time, on a single screen, the patterns of all railroad traffic as they move through the geographic region of interest. This overview capability provides a mechanism for operational look-ahead and the ability to anticipate potential congestive situations because all trains would be viewed together, thereby enabling interested observers and, perhaps, railroad dispatchers who dispatch in that geographic region, to more effectively coordinate activities.

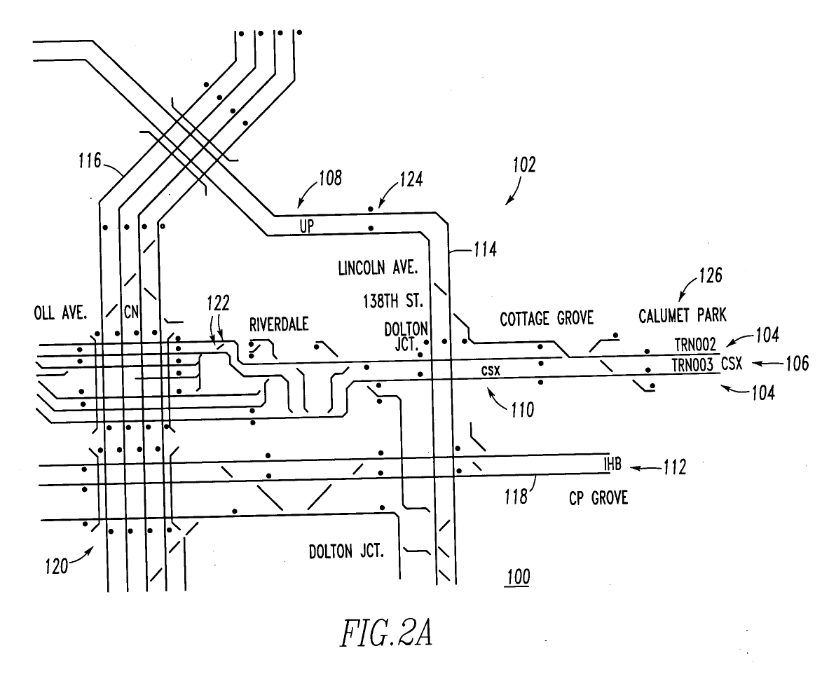

Referring to FIG. 2A, a user interface, such as a single overview display screen 100, for a geographic region 102 of interest depicts objects 104, such as tracks, trains (e.g., TRN002 and TRN003), movement authorities and field devices, for all of the one or more railroads 106,108,110,112 of interest. Although four different railroads are shown, the display screen 100 may be applied to one or more railroads. The example display screen 100 is employed for railroad dispatch monitoring of the geographic region 102 including the one or more railroads 106,108,110,112 each having a plurality of train tracks, such as 114,116,118, which include a plurality of directions. The display screen 100 includes a plurality of train track diagrams 120 for the geographic region 102. The train track diagrams 120 are substantially oriented in (a) at least a first direction, such as horizontal as shown by train track 118, and (b) a different second direction, such as vertical as shown by train track 114, which is substantially normal to the first direction. Both of the at least a first direction and the different second direction approximate the directions of the train tracks of the geographic region 102.

### EXAMPLE 1

One of the first direction and the different second direction is North-South.

### EXAMPLE 2

One of the first direction and the different second direction is East-West.

### EXAMPLE 3

The train track diagrams 120 are substantially oriented in a North-South direction, an East-West direction and at least one diagonal direction (e.g., as shown by the train track 116) in between the North-South direction and the East-West direction.

### EXAMPLE 4

The train track diagrams 120 include one, some or all of the objects 104, such as a plurality of tracks, a plurality of switches, a plurality of signals, a plurality of train positions, a plurality of movement authorities, a plurality of field devices, a plurality of train occupancies, and a plurality of train symbols.

### EXAMPLE 5

Each of the different railroads 106,108,110,112 include one, some or all of the objects 104 of Example 4.

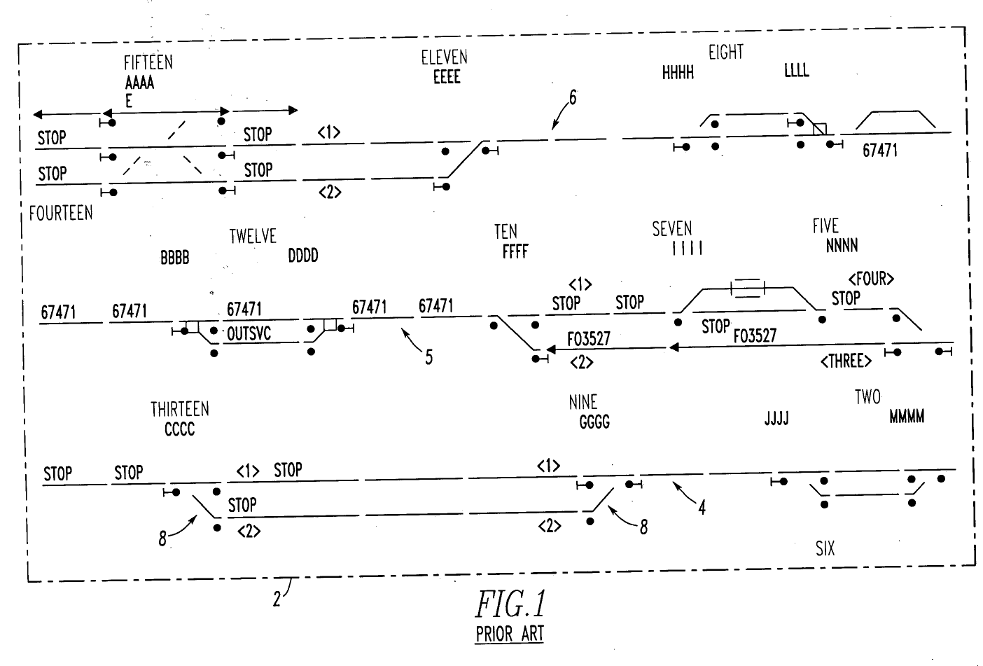

The example overview display screen 100 is an all-encompassing track display that provides substantial improvements in railroad operational awareness. Since the tracks, such as 114,116,118, are drawn in order that they appear like those that dispatchers have on their computer screens, albeit for a single railroad and albeit for a single orientation (e.g., East-West), railroad operations personnel may use the overview display screen 100 to monitor trains, such as TRN002 and TRN003. Hence, there is at least one important difference between the disclosed overview display screen 100 for one or more railroads' tracks and what dispatchers currently see on their screens. As shown in FIG. 1, dispatchers' computer screens have traditionally drawn the tracks 4,5,6 for a single railroad substantially horizontally (including, for example, diagonal turnouts 8), regardless of their actual directions in the “Z” configuration 2. In other words, such traditional dispatch computer screens have shown substantially horizontal tracks 4,5,6 (including, for example, diagonal turnouts 8) irrespective of whether the tracks are actually running North-South, East-West or directions in between. Clearly, this representation of tracks will not work if plural railroads are to be displayed. In other words, some sense of direction must be inherent in the layout, while still having it conform, as much as possible, to the “look and feel” of tracks, trains and field devices as they appear on dispatchers' screens with the substantially uni-directional “Z” configuration 2 of FIG. 1. Hence, the disclosed overview display layout and plural railroad data integration provides better railroad traffic management in high density areas where multiple railroad lines meet.

In the example of FIG. 2A, just as with the “Z” configuration track layouts of FIG. 1, the overview display screen 100 is not to scale. Furthermore, the overview display screen 100 is not a Geographic Information System (GIS) map of the same information, since there is no latitude-longitude information (e.g., the display screen 100 is not necessarily to scale), but, unlike the “Z” configuration track layouts, the “sense of direction” is added.

### EXAMPLE 6

The example overview display screen 100 of FIG. 2A is for a relatively small portion of the geographic region 102 of interest (e.g., without limitation, the Chicago region). As shown, there are a plurality (e.g., without limitation, four, although one, two, three, five or more may be employed) of different railroads' tracks being displayed. This overview display demonstrates the importance of direction (e.g., without limitation, North-South and East-West) when there are plural different railroads 106,108,110,112 being depicted.

### EXAMPLE 7

The example overview display screen 100 shows tracks 114,116,118, including switches 122 and signals 124, and one or more example train occupancy or train symbols (TRN002 and TRN003, which are under (with respect to FIG. 2A) control point 126, Calumet Park), although none, one, three or more train occupancies or train symbols may be displayed. For example, for purposes of the display screen 100, each of the railroads 106,108,110,112 may have zero, one or more trains each having a position. The overview display screen 100 and the train track diagrams 120 display the position(s) of the train(s). Preferably, these positions are displayed in real time as the trains move through the geographic region 102.

### EXAMPLE 8

FIG. 2B shows a different portion of the same general geographic region 102 (FIG. 2A) of interest in which, for example, there are no train symbols. Here, the example overview display screen 128 is part of an array 130 of a plurality of display screens 132,134,136,138,128,140,142,144,146 displaying the entire geographic region 102 of interest. The user interface formed by the array 130 may, thus, present the entire geographic region 102 of interest at one time in sufficient detail.

### EXAMPLE 9

The example overview display screen 100 of FIG. 2A may preferably include zooming capabilities, a “declutter” facility in order that wider views (those showing relatively more of the geographic region 102 of interest) will be readable, and scrolling, both horizontal and vertical. In the disclosed example, this will enable the entire Chicago area to be navigated from a single computer screen.

### EXAMPLE 10

Besides scrolling, navigation may also be based on control points (e.g., such as control point 126, Calumet Park, of FIG. 2A) and train ids (e.g., TRN002; TRN003 of FIG. 2A), in order that inputting such information will automatically center the display screen 100 on that control point or train id, thereby providing a convenient and fast search facility.

In order to realize the benefits of an overview display, such as the overview display screens 100,128 of FIGS. 2A and 2B, which are intended for monitoring, one important issue needs to be addressed—the display system needs to access the train and infrastructure data of all railroads of interest. These operating data are currently processed and managed by the different and diverse CAD systems of the individual railroads, which automate much of the information exchange between the dispatcher and the field. The problem is that the various operating data, including, for example, switch positions, train locations and signal aspects, are represented differently by each CAD system supplier. Clearly, such diversity makes it difficult to create an overview display of all the railroads of interest, especially when different suppliers are reluctant to reveal their proprietary message structures and data formats.

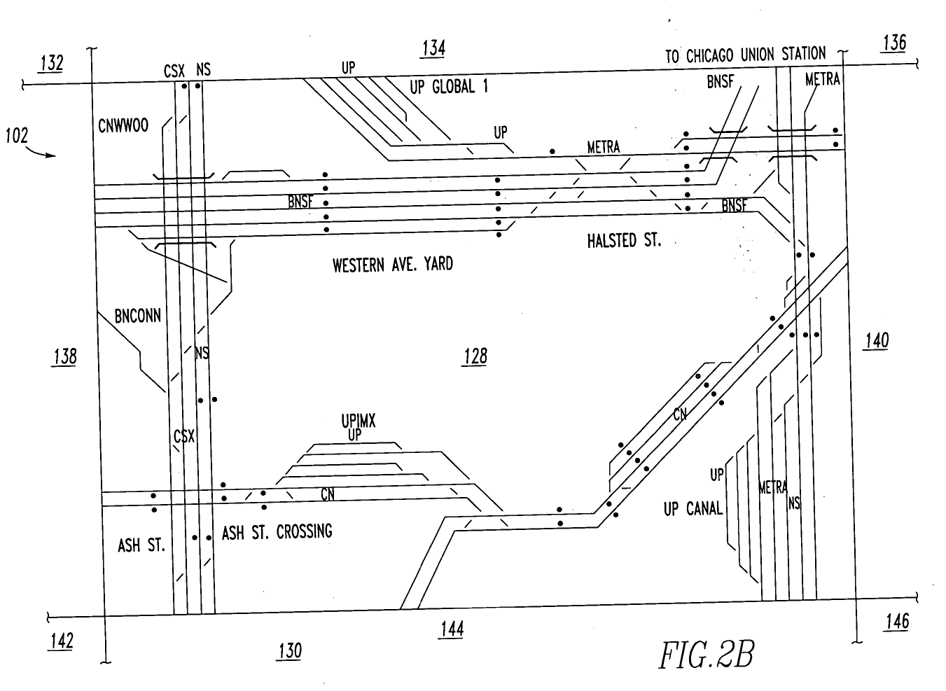

Referring to FIG. 3, a display system 200 for displaying information from a plurality of different and diverse railroad Computer-Aided Dispatch (CAD) systems 202 (or data or information about trains from one or more railroad Management Information System (MIS) systems 204 through one or more of such CAD systems 202) includes a server, such as the example web server 206, a number of display clients 208,210,212 served by the web server 206, and a plurality of data interfaces 214 communicating to the web server 206 employing a common data format 216. Each of at least some of the data interfaces 214 is structured to receive a different and diverse data format, such as 218,220, from a corresponding one of the different and diverse railroad CAD systems 202 and convert the same to the common data format 216. The different and diverse railroad CAD systems 202 are associated with different railroads (e.g., without limitation, IHB, Metra, CSX, UP, NS, BNSF, CN, CP, BRC).

### EXAMPLE 11

The different and diverse railroad CAD systems 202 include a plurality of different proprietary data formats, such as 218,220. The data interfaces 214 include corresponding conversion programs, such as 222,224, structured to translate a corresponding one of the proprietary data formats 218,220 to the common data format 216.

### EXAMPLE 12

At least some of the data interfaces 214, such as 226,228, include the same type of physical interface 230 to corresponding ones of the different and diverse railroad CAD systems, such as 232,234.

### EXAMPLE 13

At least some of the data interfaces 214, such as 236,238, include different types of physical interfaces 240,241 to corresponding ones of the different and diverse railroad CAD systems, such as 242,244.

### EXAMPLE 14

Examples of the different types of physical interfaces include a commercial middleware link 246 and a serial link 250 to a communication gateway 249 of one of the data interfaces 214 interfaced to the web server 206. Preferably, the outputs of the data interfaces 214 employ commercial middleware links to the web server 206.

### EXAMPLE 15

Examples of the different data interfaces 214 include at least one of a commercial middleware interface 247, and a raw socket interface 248 to the web server 206.

### EXAMPLE 16

Another example of the different data interfaces 214 is a communication gateway 249 including one or more serial links (e.g., serial port interfaces) 250 to one 251 of the different and diverse railroad CAD systems 202. As with Example 15, the communication gateway 249 may further include at least one of a commercial middleware interface and a raw-socket interface.

### EXAMPLE 17

The data interfaces 214 communicate to the web server 206 by further employing at least one communication protocol, such as 252,254.

### EXAMPLE 18

The display clients 208,210,212 include a plurality of displays, which may include the train track diagrams 120 of FIG. 2A. The common data format 216 describes, for example, device state changes, train movements for use in updating the displays, and/or a plurality of states (e.g., without limitation, a switch normal state; a switch reverse state) employed to display devices in the train track diagrams 120.

### EXAMPLE 19

Non-limiting examples of the display clients 208,210,212 include a number of personal computer clients 208 (e.g., without limitation, for displaying an overview display), one or more personal digital assistant clients 210 (e.g., without limitation, for displaying train status lineups) and a train dispatch display, such as the example real time train dispatch display 212. For example, the personal computer clients 208 employ a local area network connection 256 to the web server 206, the personal digital assistant client 210 employs a wireless connection 258 to the web server 206, and the train dispatch display 212 employs a web-based HTTP(S) Internet or intranet connection 260.

### EXAMPLE 20

The display clients 208,210,212 are preferably structured to report, monitor or display railroad information and/or to control a railroad.

The common data format 216, as will be described, is employed for communicating data from plural different and diverse railroad CAD systems 202 to the web server 206, which uses that data. The common data format 216 enables the different suppliers to build data interfaces between their respective CAD systems 202 and the “outside world” without revealing proprietary information. The data interface 214 to each CAD system 202 consists of a corresponding conversion program, such as 222 or 224, that translates each supplier's proprietary data format, such as 218,220 to the common data format 216. The common data format 216 enables information to be selectively displayed for all the railroads of interest that have one or more tracks in the geographic region (e.g., 102 of FIGS. 2A and 2B) of interest.

### EXAMPLE 21

The common data format 216 (e.g., open interface data protocol) is preferably encoded using (e.g., written in) XML (eXtensible Markup Language), which is a data formatting language for exchange of data over IP networks. Other suitable languages may be employed which include device state descriptions; that is, the schema they provide represent devices at the state level. Example alternatives to XML include using Common Object Request Broker Architecture (CORBA) or any suitable Remote Procedure Calling (RPC) interface.

The example XML schema describes device state changes, in order that they can be interpreted at the web server 206 for use in updating the display clients 208,210,212. XML is also advantageous because of its use of strings to represent data, thereby making it relatively easy to extend. For example, Electronic Data Interchange (EDI) and Advanced Train Control System (ATCS) do not provide for the kind of extensibility inherent in XML. XML is becoming a widely accepted data formatting language for the exchange of data over IP networks. The disclosed message formats are intended to be structurally simple, in order for a conversion program, such as 222,224, to be readily provided for any CAD system, such as 202.

An example of the disclosed message formats is as follows:

Appendix A shows an example of XML schema (e.g., schemas are conventionally represented as XML documents; structures (http://www.w3.org/TR/xmlschema-1/); datatypes (http://www.w3.org/TR/xmlschema-2/); see, for example, http://www.w3.org/2001/XMLSchema) for various device states, such as, for example and without limitation, signal, switch and/or track states. The XML schema definition is employed to validate a state map as it is parsed into memory. The target namespace, http://www.domain.com/cop/statemap, is the namespace for the schema. This namespace uniquely identifies the schema and is used to avoid collisions with elements in other schemas.

Appendix B is an example output file showing the communication of XML messages. This includes a sample of the XML data that is exchanged between a particular CAD system, such as 202, and the web server 206. For example, one such XML messages is as follows:

```
<cop:message xmlns:cop=“http://www.domain.com/cop”>
  <signal name=“9” owner-name=“5564”>
    <control>
      <clear>true</clear>
    </control>
  </signal>
```

This XML fragment conveys that Signal 9 at Control Point 5564 has a clear control issued. The XML schema of Appendix A is designed such that the devices are referenced using external nomenclature and the device states are represented using common operating state names. The string “http://www.domain.com/cop” of Appendix B is the namespace for the schema employed to validate the common operating messages.

Appendix C shows an example state map XML file for translation between CAD messages for one of the CAD systems 202 of FIG. 3 and the XML schema of Appendix A where “local” specifies the CAD message and “global” specifies the common XML message that every CAD system supplier of interest will employ. The state map XML file is employed to map between local (e.g., proprietary CAD format) and global (or common operating) state names. Hence, a specific CAD vendor employs a suitable corresponding state map XML file to generically translate between the vendor's proprietary representations of states (e.g., for signals, switches and/or tracks) and the common operating representation. Each device type contains elements that describe the mappings for controls, indications and office controls.

### EXAMPLE 22

Continuing to refer to FIG. 3, the example overview display system 200 provides the entire communications pathway from various different and diverse CAD systems 202 to one or more overview displays (e.g., at the display clients 208), along with various corresponding data interfaces 214 employed to communicate the corresponding CAD (or MIS) data to the overview display in the correct common data format 216. This example is for a selected geographic region of interest (e.g., without limitation, the Chicago area) and includes various different Class 1 railroads (e.g., without limitation, CSX, UP, NS, BNSF, CN and CP), the Indiana Harbor Belt (IHB) railroad, the Belt Railroad of Chicago (BRC) and Metra. The example overview display screen 100 of FIG. 2A shows four different railroads, including, for example and without limitation, railroad names CSX, CN, UP and IHB, although the system 200 is applicable to the display of two or more different railroads.

At the bottom of FIG. 3, the CAD systems 202 of the different railroads that run through the Chicago area are represented. Each of these CAD systems 202 is interfaced to the rest of the system 200 by a corresponding data interface conversion program, such as 222,224, that translates the respective CAD system's proprietary data format, such as 218,220, to the common data format 216, for example, using the XML message format of Example 21. Hence, this provides a mechanism for each CAD system's supplier to protect its proprietary interface information (i.e., the specific messages and message structures that the corresponding supplier uses to communicate between its CAD system 202 and the field).

Each message that is translated into the example XML message format is communicated to the central web server 206. Just as the example XML message format is intended to facilitate conversion of the data, the communication of the data may be facilitated by a wide range of different physical communication protocols (e.g., without limitation, a serial connection or link to a communication gateway for CAD systems 202 employing relatively older platforms; a commercial network; commercial middleware for CAD systems 202 employing relatively modem platforms). The use of various communication protocols provides the various different CAD systems 202 with a plurality of different options for interfacing to the system 200.

When the web server 206 receives a message from one of the data interfaces 214, the received message is processed by a display subsystem 262, thereby rendering it accessible to any authorized user at the display clients 208,210,212 that has access through one of the example connections 256,258,260. Preferably, the web server 206 employs a secure login function 263 for the display clients 208,210,212. Hence, not only will the received message be available to those display clients monitoring the example Chicago geographic region, but it could also be made accessible to other railroad personnel for remote viewing. Moreover, as a message formatting language, XML allows any product or system that adheres to the common data format 216 to be interfaced to any CAD system 202, which will benefit the railroad industry as a whole.

The disclosed system 200 does not require a lot of expensive equipment or software in order to be used. Because no proprietary software is needed by the one or more display clients 208,210,212, the only software employed is a web browser, such as 264, which has become standard issue for all computers.

The overview displays of the display clients 208 preferably employ multiple railroad trackage in a separate track database (not shown) with respect to the different and diverse CAD systems 202 because of the nature of the overview display screens, such as 100,128 of FIGS. 2A and 2B.

### EXAMPLE 23

For purposes of showing all of the device state changes, the example system 200 is preferably event-driven, which means that whenever there is a change in the state of the field for any of the various railroads being displayed, that information is pushed out to the display clients 208,210,212 as soon as it is received by the web server 206. Preferably, latency is minimized. Furthermore, the freshness of the data will be known at all times because the web server 206 preferably continually monitors the connections to the respective CAD systems 202 to see if they are alive. The data interfaces 214 and the web server 206 are event-driven in response to changes in state of the different and diverse railroad CAD systems 202. The web server 206 receives one of the changes in state from a corresponding one of the different and diverse railroad CAD systems 202 and responsively outputs the same to the display clients 208,210,212.

### EXAMPLE 24

As an alternative to being event-driven, the example system 200 may employ polling to manage updates. The polling system is accessed, for example, as a typical web application with a standard web browser, such as 264, on the display client, such as 212. The polling system may not show all of the device state changes, but can be accessed by more types of display client machines. The web server 206 polls the data interfaces 214 to receive changes in state of the corresponding CAD systems 202. The web server 206 receives one of the changes in state from a corresponding one of the CAD systems 202 and responsively outputs the same to the display clients 208,210,212.

### EXAMPLE 25

As an alternative to Examples 23 and 24, the example system 200 may employ full screen updates in which data is acquired over a suitable predetermined time period (e.g., without limitation, during about five to about six seconds), before updating the full screens of the display clients 208,210,212 at one time for each screen. The web server 206 acquires from the data interfaces 214 a plurality of changes from the CAD systems 202 over the predetermined time period, and then outputs all of the changes.

### EXAMPLE 26

The system 200 may employ data analysis tools (not shown) for trending and measurement. As non-limiting examples, these tools may include various functions to: (1) collect, store and analyze train position data; (2) generate reports on performance (e.g., by train; by train type; by area); and (3) access reports through data servers via the Internet.

### EXAMPLE 27

The system 200 may employ event logging and playback capabilities. As non-limiting examples, these capabilities may include various functions to: (1) record all train moves and device state changes from messages sent to the display; (2) display simulated playback on overview screens; (3) filter event logs (e.g., by time; by events; by train number); and (4) display playback and event logs via the Internet.

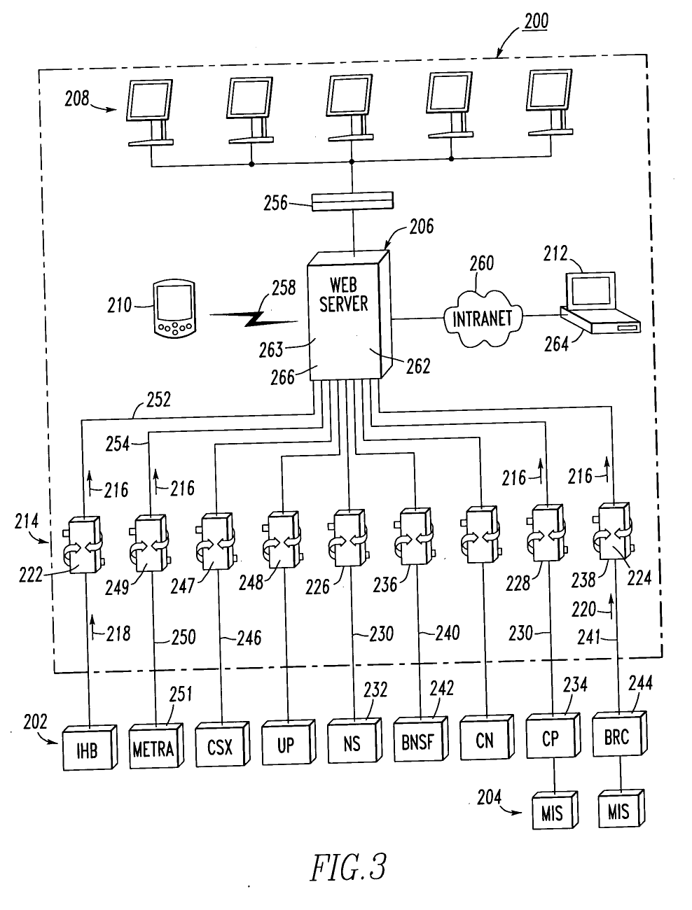

Referring to FIG. 4, a flowchart 300 of firmware executed by one of the CAD message conversion programs, such as 222 or 224 of FIG. 3, is shown. First, at 302, a state change is received from the corresponding CAD system 202. Next, at 304, it is determined if the state of the state change is translatable. In the example conversion process, a state is translatable if the state is in the corresponding state element map (e.g., without limitation, as shown in Appendix C). If so, then at 306, the local CAD state is mapped to the global common operating picture (COP) state of the common data format 216 of FIG. 3. Next, at 308, a corresponding XML state message is built. Then, at 310, the XML state message is sent to the web server 206 through the corresponding communication protocol, such as 252 or 254. Finally, after 310 or if the test at step 304 failed, the conversion process exits at 312.

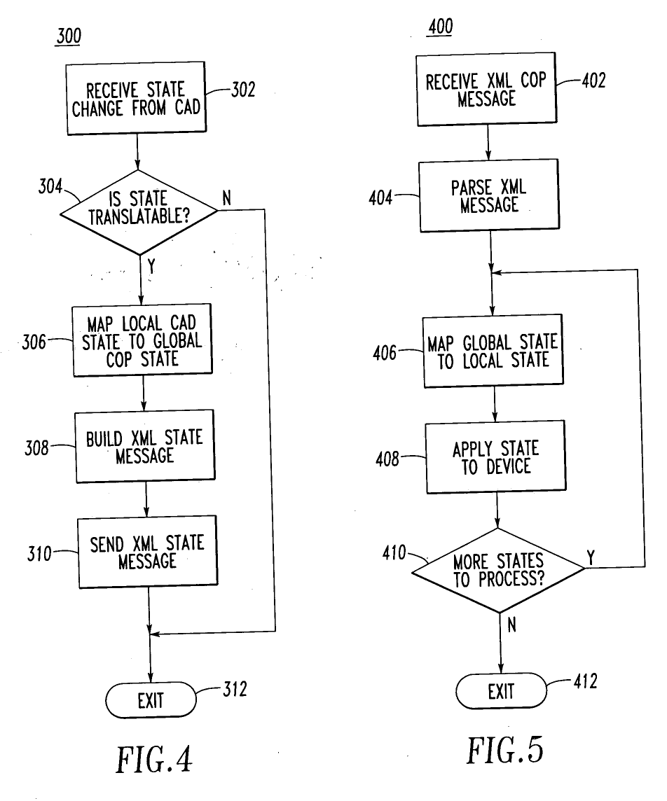

FIG. 5 is a flowchart 400 of firmware executed by the web server 206 of FIG. 3. First, at 402, the XML COP message (from step 310 of FIG. 4) is received by the web server 206 from one of the data interfaces 214 of FIG. 3. Next, at 404, the XML message is parsed. Then, at 406, the web server 206 maps the global state to local state. This converts the state representation in the COP language to the state representation of the web server 206. When the web server 206 receives the state update, it converts the common, global representation to another suitable local representation, which is employed by the web server 206 to update the COP display subsystem 262 of FIG. 3 and to ultimately the display the state change. Next, at 408, the state is applied to the device. This results in the device display of the display clients 208,210,212 being changed. The web server 206 includes cooperating subsystems 262,263,266 of FIG. 3. The state management subsystem 266 manages all device state changes and reports those changes to other, interested subsystems, such as the display subsystem 262, which is responsible for changing the device display based on the state change. A control point (CP element), such as owner-name 5564 (Appendix B), is at the top of the device hierarchy. It is both an owner of other devices and a device itself. Therefore, the owner attribute of the CP element is redundant. This owner attribute is present within the CP element to allow for generic parsing of all devices, control points included.

The disclosed system 200 of FIG. 3 permits the monitoring of plural different railroads with integrated train track diagrams, such as 120 of FIG. 2A, and the common data format 216 from a plurality of different and diverse railroad CAD systems 202. This provides a seamless overview of all the different railroads' tracks, devices and trains in the geographic region of interest. The system 200 constructs overview display screens, such as 100 of FIG. 2A, using track data from the plural CAD systems 202. The data interfaces 214 convert data to the common data format 216 for display, and send the data to the web server 206 for the display clients 208,210,212.

A primary benefit of the disclosed plural railroad monitoring system 200 is to reduce congestion and improve on-time performance through the use of a single dispatch-like overview display screen, such as 100 of FIG. 2A, of all the different railroads involved, in order that train moves can be better coordinated. A second benefit is improving public/railroad relations, since the traveling public will benefit from reduced delays, more reliable service, and potentially reduced commuting times. Furthermore, for the motoring public, less traffic delays due to blocked grade crossings are expected. Reduction of dwell times of railroad traffic transiting through the geographic region of interest will also reduce operating costs by providing more efficient operations (e.g., fuel savings; lowered locomotive emissions). These improvements improve safety by reducing human or technology failures, and enhance revenue generating capability by attracting more riders through reducing trip times, upgrading customer service quality, increasing reliability and/or improving on-time performance. The improvements also enhance the social benefits or environmental aspects of high speed railroads. Finally, improved throughput will help reduce the need for infrastructure improvements such as, for example, additional track and turnouts.

While for clarity of disclosure reference has been made herein to the exemplary overview display screens 100,128 for displaying train track diagrams 120, data or information from plural different and diverse railroad CAD systems 202, it will be appreciated that such diagrams, data or information may be stored, printed on hard copy, be computer modified, or be combined with other data. All such processing shall be deemed to fall within the terms “display” or “displaying” as employed herein.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

APPENDIX A
<xsd:schema xmlns:xsd=“http://www.w3.org/2001/XMLSchema”

targetName space=“http://www.domain.com/cop/statemap”
xmlns:sm=“http://www.domain.com/cop/statemap”
elementFormDefault=“unqualified”>

<xsd:annotation>

<xsd:documentation xml:lang=“en”>

State map schema for Common Operating Picture

</xsd:documentation>

</xsd:annotation>
<!--

TODO design your vocabulary here.
XML Schema Primer: http://www.w3.org/TR/xmlschema-0/
Structures recommendation: http://www.w3.org/TR/xmlschema-1/
Datatypes recommendation: http://www.w3.org/TR/xmlschema-2/

-->

<xsd:element name=“statemap” type=“sm:statemapType”/>
<xsd:element name=“version” type =“xsd:string”/>
<xsd:complexType name=“statemapType”>

<xsd:all>

<xsd:element name=“CP” type=“sm:deviceMappingType”/>
<xsd:element name=“SG” type=“sm:deviceMappingType”/>
<xsd:element name=“SW” type=“sm:deviceMappingType”/>
<xsd:element name=“TK” type=“sm:deviceMappingType”/>

</xsd:all>

</xsd:complexType>
<xsd:complexType name=“deviceMappingType”>

<xsd:all>

<xsd:element name=“control” type=“sm:stateListType”/>
<xsd:element name=“indication” type=“sm:stateListType”/>
<xsd:element name=“data” type=“sm:stateListType” minOccurs = “0”/>

</xsd:all>

</xsd:complexType>
<xsd:complexType name=“stateListType”>

<xsd:sequence>

<xsd:element name=“state” type=“sm:stateEntry” maxOccurs=“unbounded”/>

</xsd:sequence>

</xsd:complexType>
<xsd:complexType name=“stateEntry”>
<xsd:attribute name=“local” use=“required” type=“xsd:string”/>
<xsd:attribute name=“global” use=“required” type=“xsd:string”/>

</xsd:complexType>

</xsd:schema>

```
APPENDIX B
<?xml version=“1.0” standalone=“no” ?>
<copdata>
    <cop:message xmlns:cop=“http://www.domain.com/cop”>
        <signal name=“9” owner-name=“5564”>
          <control>
              <clear>true</clear>
          </control>
        </signal>
    </cop:message>
    <cop:message xmlns:cop=“http://www.domain.com/cop”>
        <signal name=“9” owner-name=“5564”>
          <indication>
              <clear>true</clear>
          </indication>
        </signal>
    </cop:message>
    <cop:message xmlns:cop=“http://www.domain.com/cop”>
        <track name=“018” owner-name=“5564”>
          <office>
            <clear-busy-right>true</clear-busy-right>
          </office>
        </track>
    </cop:message>
    <cop:message xmlns:cop=“http://www.domain.com/cop”>
      <track name=“009” owner-name=“5564”>
          <office>
            <clear-busy-right>true</clear-busy-right>
          </office>
    </track>
    </cop:message>
      <cop:message xmlns:cop=“http://www.domain.com/cop”>
        <track name=“011” owner-name=“5564”>
          <office>
        <clear-busy-right>true</clear-busy-right>
      </office>
    </track>
    </cop:message>
    <cop:message xmlns:cop=“http://www.domain.com/cop”>
      <track name=“111” owner-name=“5564”>
        <office>
          <clear-busy-right>true</clear-busy-right>
        </office>
      </track>
    </cop:message>
    <cop:message xmlns:cop=“http://www.domain.com/cop”>
      <control-point name=“5564” owner-name=“5564”>
        <office>
          <selected>true</selected>
        </office>
      </control-point>
    </cop:message>
    <cop:message xmlns:cop=“http://www.domain.com/cop”>
      <track name=“018” owner-name=“5564”>
        <office>
          <request-clear-busy-right>false</request-clear-busy-right>
        </office>
      </track>
    </cop:message>
    <cop:message xmlns:cop=“http://www.domain.com/cop”>
      <track name=“009” owner-name=“5564”>
        <office>
          <request-clear-busy-right>false</request-clear-busy-right>
        </office>
      </track>
    </cop:message>
    <cop:message xmlns:cop=“http://www.domain.com/cop”>
      <track name=“011” owner-name=“5564”>
        <office>
          <request-clear-busy-right>false</request-clear-busy-right>
        </office>
      </track>
    </cop:message>
    <cop:message xmlns:cop=“http://www.domain.com/cop”>
      <track name=“111” owner-name=“5564”>
        <office>
          <request-clear-busy-right>false</request-clear-busy-right>
        </office>
      </track>
    </cop:message>
    <cop:message xmlns:cop=“http://www.domain.com/cop”>
      <control-point name=“5564” owner-name=“5564”>
        <office>
          <selected>false</selected>
        </office>
      </control-point>
    </cop:message>
    <cop:message xmlns:cop=“http://www.domain.com/cop”>
      <signal name=“9” owner-name=“5564”>
        <indication>
          <intime>true</intime>
        </indication>
      </signal>
    </cop:message>
    <cop:message xmlns:cop=“http://www.domain.com/cop”>
      <signal name=“9” owner-name=“5564”>
        <indication>
          <clear>false</clear>
        </indication>
      </signal>
    </cop:message>
    <cop:message xmlns:cop=“http://www.domain.com/cop”>
      <track name=“018” owner-name=“5564”>
        <office>
          <clear-busy-right>false</clear-busy-right>
        </office>
      </track>
    </cop:message>
    <cop:message xmlns:cop=“http://www.domain.com/cop”>
      <track name=“009” owner-name=“5564”>
        <office>
          <clear-busy-right>false</clear-busy-right>
        </office>
      </track>
    </cop:message>
    <cop:message xmlns:cop=“http://www.domain.com/cop”>
      <track name=“011” owner-name=“5564”>
        <office>
          <clear-busy-right>false</clear-busy-right>
        </office>
      </track>
    </cop:message>
    <cop:message xmlns:cop=“http://www.domain.com/cop”>
      <track name=“111” owner-name=“5564”>
        <office>
          <clear-busy-right>false</clear-busy-right>
        </office>
      </track>
    </cop:message>
    <cop:message xmlns:cop=“http://www.domain.com/cop”>
      <signal name=“9” owner-name=“5564”>
        <indication>
          <intime>false</intime>
        </indication>
      </signal>
    </cop:message>
    <cop:message xmlns:cop=“http://www.domain.com/cop”>
      <signal name=“9” owner-name=“5564”>
        <control>
          <clear>true</clear>
        </control>
      </signal>
    </cop:message>
    <cop:message xmlns:cop=“http://www.domain.com/cop”>
      <signal name=“9” owner-name=“5564”>
        <indication>
          <clear>true</clear>
        </indication>
      </signal>
    </cop:message>
    <cop:message xmlns:cop=“http://www.domain.com/cop”>
      <track name=“018” owner-name=“5564”>
        <office>
          <clear-busy-right>true</clear-busy-right>
        </office>
      </track>
    </cop:message>
    <cop:message xmlns:cop=“http://www.domain.com/cop”>
      <track name=“009” owner-name=“5564”>
        <office>
          <clear-busy-right>true</clear-busy-right>
        </office>
      </track>
    </cop:message>
    <cop:message xmlns:cop=“http://www.domain.com/cop”>
      <track name=“005” owner-name=“5564”>
        <office>
          <clear-busy-left>true</clear-busy-left>
        </office>
      </track>
    </cop:message>
    <cop:message xmlns:cop=“http://www.domain.com/cop”>
      <control-point name=“5564” owner-name=“5564”>
        <office>
          <selected>true</selected>
        </office>
      </control-point>
    </cop:message>
    <cop:message xmlns:cop=“http://www.domain.com/cop”>
      <control-point name=“5564” owner-name=“5564”>
        <office>
          <selected>false</selected>
        </office>
      </control-point>
    </cop:message>
    <cop:message xmlns:cop=“http://www.domain.com/cop”>
      <control-point name=“5564” owner-name=“5564”>
        <office>
          <selected>true</selected>
        </office>
      </control-point>
    </cop:message>
```

```
APPENDIX C
  <CP>
    <control>
      <state local=“CONTROLPOINT_Maintainer_Call_Control” global=“maintainer-
call” />
      <state local=“CONTROLPOINT_Maintainer_Call_On_Temporary”
global=“maintainer-call-on-temp” />
      <state local=“CONTROLPOINT_Maintainer_Call_Off_Temporary”
global=“maintainer-call-off-temp” />
      <state local=“CONTROLPOINT_Switch_Heater_Control” global=“switch-heater”
/>
      <state local=“CONTROLPOINT_Switch_Heater_Control_Off_Temporary”
global=“switch-heater-off-temp” />
      <state local=“CONTROLPOINT_Switch_Heater_Control_On_Temporary”
global=“switch-heater-on-temp” />
      <state local=“CONTROLPOINT_Location_Initialized” global=“initialized” />
      <state local=“CONTROLPOINT_Location_Selected” global=“selected” />
    </control>
    <indication>
      <state local=“CONTROLPOINT_Local_Control_Taken_Indication” global=“local-
control” />
      <state local=“CONTROLPOINT_Power_Off_Indication” global=“power-off” />
      <state local=“CONTROLPOINT_Switch_Heater_Indication” global=“switch-heater”
/>
      <state local=“CONTROLPOINT_Maintater_Call_Indication” global=“maintainer-
call” />
    </indication>
  </CP>
  <SG>
    <control>
      <state local=“SIGNALClear_Control” global=“clear” />
      <state local=“SIGNALClear_Prm” global=“clear-perm” />
      <state local=“SIGNALClear_Temporary” global=“clear-temp” />
      <state local=“SIGNALStop_Temporary” global=“stop-temp” />
      <state local=“SIGNALCall_On_Control” global=“call-on” />
      <state local=“SIGNALCall_On_On_Temporary” global=“call-on-on-temp” />
      <state local=“SIGNALCall_On_Off_Temporary” global=“call-on-off-temp” />
    </control>
    <indication>
      <state local=“SIGNALClear_Indication” global=“clear” />
      <state local=“SIGNALIntime_Indication” global=“intime” />
      <state local=“SIGNALBlock_Indication” global=“block” />
    </indication>
  </SG>
  <SW>
    <control>
      <state local=“SWITCH_Normal_Control” global=“normal” />
      <state local=“SWITCH_Reverse_Control” global=“reverse” />
      <state local=“SWITCH_Normal_Temporary” global=“normal-temp” />
      <state local=“SWITCH_Reverse_Temporary” global=“reverse-temp” />
    </control>
    <indication>
      <state local=“SWITCH_Normal_Indication” global=“normal” />
      <state local=“SWITCH_Reverse_Indication” global=“reverse” />
      <state local=“SWITCH_Block_Indication” global=“block” />
    </indication>
  </SW>
  <TK>
    <control>
      <state local=“TRACK_Block_Control” global=“block” />
      <state local=“TRACK_Block_On_Temporary” global=“block-on-temp” />
      <state local=“TRACK_Block_Off_Temporary” global=“block-off-temp” />
      <state local=“TRACK_Busy_Left_Temporary” global=“initialized” />
      <state local=“TRACK_Busy_Right_Temporary” global=“selected” />
      <state local=“TRACK_ReqClr_Busy_left” global=“request-clear-busy-left” />
      <state local=“TRACK_ReqClr_Busy_Right” global=“request-clear-busy-right” />
      <state local=“TRACK_Clr_Busy_Left” global=“clear-busy-left” />
      <state local=“TRACK_Clr_Busy_Right” global=“clear-busy-right” />
    </control>
    <indication>
      <state local=“TRACK_Occupied_Indication” global=“occupied” />
      <state local=“TRACK_Busy_Left_Indication” global=“busy-left” />
      <state local=“TRACK_Busy_Right_Indication” global=“busy-right” />
      <state local=“TRACK_Lock_Indication” global=“lock” />
      <state local=“TRACK_Block_Indication” global=“block” />
    </indication>
  </TK>
</sm:statemap>
```

What is claimed is:

1. A user interface for railroad dispatch monitoring of a geographic region including at least one railroad having a plurality of train tracks, said train tracks including a plurality of directions, said user interface comprising:
at least one display comprising a plurality of train track diagrams for said geographic region,
wherein said train track diagrams are substantially oriented in (a) at least a first direction and (b) a different second direction, which is substantially normal to said first direction, and
wherein both of said at least a first direction and said different second direction approximate the directions of the train tracks of said geographic region.

2. The user interface of claim 1 wherein said at least one railroad is a plurality of different railroads; and wherein said geographic region includes said different railroads.

3. The user interface of claim 1 wherein one of said first direction and said different second direction is North-South.

4. The user interface of claim 1 wherein one of said first direction and said different second direction is East-West.

5. The user interface of claim 1 wherein said first direction and said different second direction include North-South and East-West.

6. The user interface of claim 5 wherein said at least one railroad is a plurality of different railroads; wherein said geographic region includes said different railroads; and wherein said train track diagrams include a plurality of train tracks for said different railroads.

7. The user interface of claim 1 wherein said train track diagrams are substantially oriented in a North-South direction, an East-West direction and at least one diagonal direction in between said North-South direction and said East-West direction.

8. The user interface of claim 1 wherein said at least one display is a single display screen.

9. The user interface of claim 1 wherein said at least one display is an array of a plurality of display screens displaying the entire geographic region of interest.

10. The user interface of claim 1 wherein said at least one railroad includes at least one train having a position; wherein said at least one display and said train track diagrams display the position of said at least one train; and wherein the position of said at least one train is displayed in real time as said at least one train moves through said geographic region.

11. The user interface of claim 1 wherein said train track diagrams include at least some of a plurality of tracks, a plurality of switches, a plurality of signals, a plurality of train positions, a plurality of movement authorities, a plurality of field devices, a plurality of train occupancies, and a plurality of train symbols.

12. The user interface of claim 1 wherein said train track diagrams include a plurality of tracks, a plurality of switches, a plurality of signals, a plurality of train positions, a plurality of movement authorities, and a plurality of field devices.

13. The user interface of claim 2 wherein said train track diagrams include a plurality of tracks, a plurality of switches, a plurality of signals, a plurality of train positions, a plurality of movement authorities, and a plurality of field devices for each of said different railroads.

14. A display system for displaying information from a plurality of different and diverse railroad Computer-Aided Dispatch (CAD) systems, said display system comprising:
a server;
a number of display clients served by said server; and
a plurality of data interfaces communicating to said server employing a common data format, each of at least some of said data interfaces being structured to receive a different and diverse data format from a corresponding one of said different and diverse railroad CAD systems and convert the same to said common data format.

15. The display system of claim 14 wherein at least some of said data interfaces include the same type of physical interface to corresponding ones of said different and diverse railroad CAD systems.

16. The display system of claim 14 wherein at least some of said data interfaces include different types of physical interfaces to corresponding ones of said different and diverse railroad CAD systems.

17. The display system of claim 16 wherein said different types of physical interfaces include a communication network and a serial link to a communication gateway interfaced to said server.

18. The display system of claim 14 wherein said data interfaces comprise at least one of a commercial middleware interface, and a raw socket interface to said server.

19. The display system of claim 14 wherein at least one of said data interfaces comprises a communication gateway including at least one serial port interface to one of said different and diverse railroad CAD systems.

20. The display system of claim 19 wherein said communication gateway further includes at least one of a commercial middleware interface and a raw-socket interface.

21. The display system of claim 14 wherein said different and diverse railroad CAD systems are associated with different railroads; wherein said data interfaces and said server are event-driven in response to changes in state of said different and diverse railroad CAD systems; and Wherein said server receives one of said changes in state from a corresponding one of said different and diverse railroad CAD systems and responsively outputs the same to said display clients.

22. The display system of claim 14 wherein said different and diverse railroad CAD systems are associated with different railroads; wherein said server polls said data interfaces to receive changes in state of said different and diverse railroad CAD systems; and wherein said server receives one of said changes in state from a corresponding one of said different and diverse railroad CAD systems and responsively outputs the same to said display clients.

23. The display system of claim 14 wherein said different and diverse railroad CAD systems are associated with different railroads; wherein said server acquires from said data interfaces a plurality of changes from said different and diverse railroad CAD systems over a predetermined time period; and wherein said server outputs all of said changes at one time to said display clients.

24. The display system of claim 14 wherein said different and diverse railroad CAD systems include a plurality of different proprietary data formats; and wherein said data interfaces include corresponding conversion programs structured to translate a corresponding one of said proprietary data formats to said common data format.

25. The display system of claim 14 wherein said data interfaces communicate to said server by further employing at least one communication protocol.

26. The display system of claim 14 wherein said common data format is encoded using extensible Markup Language (XML).

27. The display system of claim 14 wherein said display clients include a plurality of displays; and wherein said common data format describes device state changes and train movements for use in updating said displays.

28. The display system of claim 14 wherein said display clients include a plurality of track diagrams; and wherein said common data format describes a plurality of states employed to display devices in said track diagrams.

29. The display system of claim 28 wherein said states include a switch normal state and a switch reverse state.

30. The display system of claim 14 wherein said server is a web server.

31. The display system of claim 14 wherein said display clients are selected from the group consisting of personal computer clients and personal digital assistant clients.

32. The display system of claim 14 wherein said display clients include a train dispatch display.

33. The display system of claim 32 wherein said train dispatch display is a real time train dispatch display.

34. The display system of claim 32 wherein said train dispatch display includes a plurality of train track diagrams for said geographic region; and wherein said train track diagrams are substantially oriented in at least a first direction and a different second direction which is substantially normal to said first direction.

35. The display system of claim 34 wherein said different and diverse railroad CAD systems are associated with different railroads; and wherein said train track diagrams include a plurality of tracks, a plurality of switches, a plurality of signals, a plurality of train positions, a plurality of movement authorities, and a plurality of field devices for each of said different railroads.

36. The display system of claim 14 wherein at least one of said display clients is structured to report, monitor or display railroad information or to control a railroad.
